(19) United States
(12) Patent Application Publication
(10) Pub. No.: US 2015/0110119 A1
(43) Pub. Date: Apr. 23, 2015

(54) VIRTUAL GATEWAY FOR MACHINE TO MACHINE CAPILLARY NETWORK

(71) Applicant: International Business Machines Corporation, Armonk, NY (US)

(72) Inventors: Denis Aubert, St. Paul de Vence (FR); Franck Boudinet, Villeneuve-Loubet (FR); Joaquin Picon, St. Laurent Du Var (FR); Bernard Pucci, Cagnes sur Mer (FR)

(21) Appl. No.: 14/504,122

(22) Filed: Oct. 1, 2014

(30) Foreign Application Priority Data
Oct. 18, 2013 (GB) 1318439.5

(51) Int. Cl. H04L 12/66; H04W 8/18; H04W 4/00

(52) U.S. Cl. CPC H04L 12/66; H04W 4/005; H04W 8/18
USPC 370/401

(57) ABSTRACT

A virtual gateway for communicating between one or more remote machine to machine capillary networks and a local base transceiver station includes an interface for communicating with a local base transceiver station. The interface emulates a Radio Link Control (RLC) protocol in the communication. The virtual gateway also includes an interface for communicating with one or more remote capillary networks and a SIM emulation component for emulating a SIM card. The SIM card is used in association with the interface for communicating with the local base transceiver station.

### CROSS-REFERENCE TO RELATED APPLICATIONS

This application claims the benefit of United Kingdom Application Number 1318439.5 filed on Oct. 18, 2013, which is fully incorporated herein by reference.

### BACKGROUND

A Machine-to-Machine (M2M) system is a communication system that enables a flow of data from machine to machine. Examples of M2M systems include water and gas automatic meter reading systems, smarter parking systems and environmental monitoring systems.

Many smart cities and M2M systems utilize sensors in which a conventional SIM card cannot be embedded. Such systems use gateways communicating with the sensors by means of various radio, wireless or mesh technologies. The gateways also communicate with wide area telephony networks using conventional wireless telephony. A conventional SIM card cannot be embedded because of power consumption constraints. Typically, 2G, 2.5G, 3G or 4G wireless chipsets are used with a SIM and the power consumption of such wireless chipsets combined with the power required for the socket to power the SIM card is too high for a sensor that is not connected to the electricity network or which does not have a battery replaced regularly. For example, a water meter sensor should be able to operate for 5 to 10 years without requiring a battery to be replaced. This is not possible with the power consumption needed for a SIM card version. The use of these gateways add to the costs, reduces the return on investment of these systems and adds to the maintenance costs.

FIG. 1 shows a conventional prior art M2M system. Business Applications Data Collection 102 connected to the Internet 104 communicates through a Wide Area Network (WAN) 106 with gateways 108, 110. WAN 106 comprises a Base Station Controller (BSC) 140 and a Base Transceiver Station (BTS) 142. BSC 140 controls and supervises a group of underlying BTSs 142. BSC 140 controls such actions as the transmitting power to be used and when and what is transmitted.

BTS 142 handles the actual radio communication with the gateways 108, 110. The SIMs 144, 146 located within the gateways 108, 110 provides the gateways 108, 110 with all the user subscription information and personalization required in order for the gateways 108, 110 to be able to communicate with the base transceiver station 142. SIMs 144, 146 are not tied to a specific gateway 108, 110 and could be used in any gateway 108, 110 in the same manner as a SIM card can be used in any unlocked mobile phone. The registered owner of the SIMs 144, 146 is charged for the costs associated with the communication between the gateways 108, 110 and the base transceiver station 142. The SIMs 144, 146 contain information that is stored by the telecommunications operator and cannot be changed, such as the International Mobile Subscriber Identity (IMSI) and the authentication key Ki. The IMSI identifies the subscriber within the GSM network, and the Ki is used for security purposes. The SIM may also contain temporary stored information, such as network information that changes over time as well as information that is service-related such as language preferences, phonebook, short messages, call log and the like.

Gateways 108, 110 communicate with capillary networks 112, 114. Sensors 116-134 are connected to capillary networks 112, 114. Communication between gateways 108, 110 and capillary networks 112, 114 may be by means of short range wired or wireless technologies. Examples of such short range wireless technologies include Wifi, Bluetooth or RFID. In a typical utility metering application, a gateway 108, 110 may be connected to around 50 sensors, the sensors forming a capillary network 112, 114. Again in a typical utility metering application, perhaps 250,000 utility meters may be required to be connected. This would typically require 5,000 gateways 108, 110, each gateway 108, 110 requiring a physical location where there is a power supply and each gateway 108, 110 requiring a SIM 144, 146.

In some cases, a system of M2M devices is connected to M2M servers in which M2M devices can be freely moved from a first gateway to a second gateway. A M2M registrar contains subscription data for M2M devices and answers queries from M2M media handlers and M2M servers with the identity of a M2M media handler handling the M2M device.

### SUMMARY

A virtual gateway for communicating between one or more remote machine to machine capillary networks and a local base transceiver station includes an interface for communicating with a local base transceiver station. The interface emulates a Radio Link Control (RLC) protocol in the communication. The virtual gateway also includes an interface for communicating with one or more remote capillary networks and a SIM emulation component for emulating a SIM card. The SIM card is used in association with the interface for communicating with the local base transceiver station.

A method of communicating between one or more remote machine to machine capillary networks and a local base transceiver station includes providing an interface for communicating with a local base transceiver station. The interface emulates an RLC protocol in the communication. The method includes providing an interface for communicating with one or more remote machine to machine capillary networks and providing a SIM emulation component for emulating a SIM card. The SIM card is used in association with the interface for communicating with the local base transceiver station.

A computer program product for communicating between a remote machine to machine capillary network base and a local base transceiver station includes a computer readable storage medium having computer readable program code embodied therewith. The computer readable program code is executable by a processor to perform a method. The method includes providing an interface for communicating with a local base transceiver station. The interface emulates an RLC protocol in the communication. The method includes providing an interface for communicating with one or more remote machine to machine capillary networks and providing a SIM emulation component for emulating a SIM card. The SIM card is used in association with the interface for communicating with the local base transceiver station.

### BRIEF DESCRIPTION OF THE SEVERAL VIEWS OF THE DRAWINGS

Preferred embodiments of the present invention will now be described in more detail, by way of example only, with reference to the accompanying drawings, in which:

FIG. 1 shows a prior art M2M system comprising gateways having SIMs embedded therein;

FIG. 2 shows an embodiment of an M2M system according to the present invention comprising one or more BTSs having VSIMs embedded therein;

FIG. 3 shows an expanded view of a portion of the embodiment of FIG. 2 showing the protocols used between the BTSs and the sensors;

FIG. 4 shows a prior art GPRS protocol stack used in an OpenBTS architecture embodiment of the invention; and

FIG. 5 shows the main components in an embodiment of a virtual gateway according to the present invention.

### DETAILED DESCRIPTION

The embodiments disclosed herein relate to a virtual gateway for a machine to machine capillary network and more particularly to a virtual and shared gateway including a SIM management function.

The embodiments provide a virtual gateway for communicating between one or more remote machine to machine capillary networks and a local base transceiver station, where the virtual gateway comprises: an interface for communicating with a local base transceiver station, the interface emulating a Radio Link Control (RLC) protocol in said communication; an interface for communicating with one or more remote capillary networks; and a SIM emulation component for emulating a SIM card, the SIM card being used in association with the interface for communicating with the local base transceiver station.

This has the advantage that as far as the local base transceiver station is concerned, the virtual gateway is a conventional mobile interface using RLC protocol for its communication.

In a preferred embodiment, the virtual gateway is co-located with the local base transceiver station.

This has the advantage that the SIM card and associated chipset can be supplied with power from an existing base station transceiver and that the virtual gateway is also located at an existing base station transceiver.

In a preferred embodiment, the interface emulating an RLC protocol uses an inter-process data transmission mechanism.

In an embodiment, the interface for communicating with one or more remote capillary networks uses short distance wired or wireless communication.

In an embodiment, the virtual gateway uses GPRS protocols for communication with the local base transceiver station.

The embodiments also provide a method of communicating between one or more remote machine to machine capillary networks and a local base transceiver station, the method comprising the steps of: providing an interface for communicating with a local base transceiver station, the interface emulating a RLC protocol in said communication; providing an interface for communicating with one or more remote capillary networks; and providing a SIM emulation component for emulating a SIM card, the SIM card being used in association with the interface for communicating with the local base transceiver station.

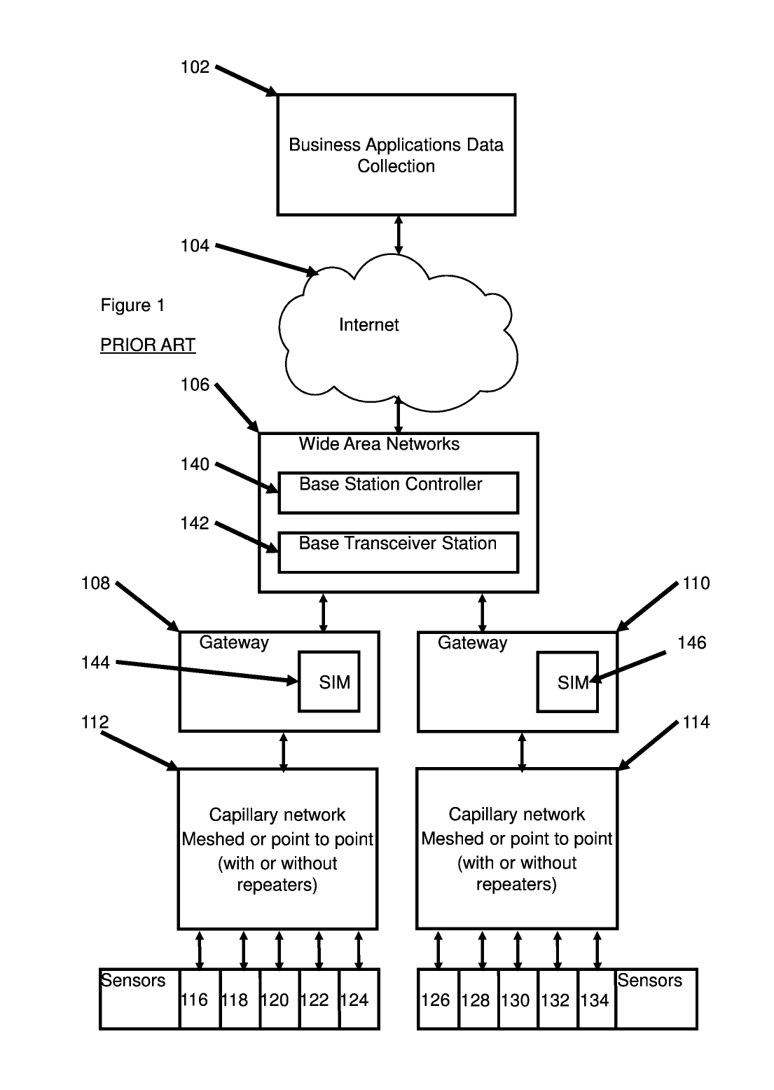

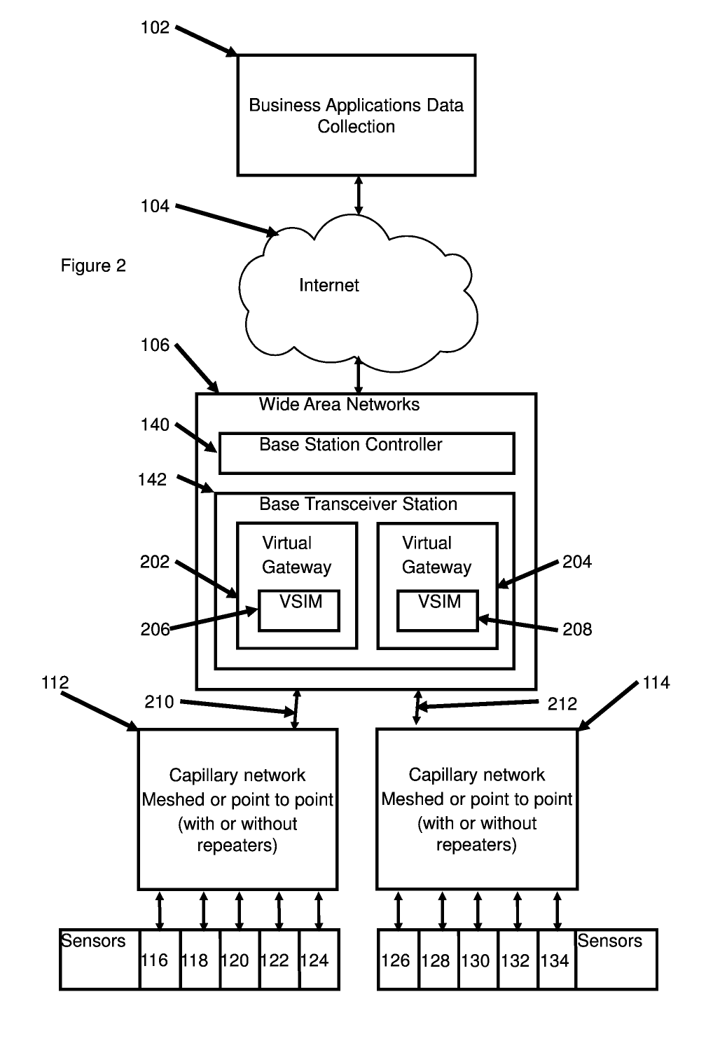

Referring to FIG. 2, an embodiment of an M2M system comprising Business Applications Data Collection 102, Internet 104, WAN 106 having BSC 140, one or more BTSs 142 having virtual gateways 202, 204 with VSIMs 206, 208 embedded therein is shown. Also shown are capillary networks 112, 114 and sensors 116-134. Business Applications Data Collection 102, Internet 104, BSC 140, capillary networks 112, 114 and sensors 116-134 are the same as those shown in the prior art FIG. 1. WAN 106 differs from that shown in FIG. 1 in that separate gateways 108, 110 are not used in this embodiment of the present invention, but are replaced by virtual gateways 202, 204 included in Wide Area Network 106. These virtual and shared gateways 202, 204 are directly integrated with the Telco operator networks.

BTS 142 has virtual gateways 202, 204 including VSIMs 206, 208 used to provide connections 210, 212 through capillary networks 112, 114 to sensors 116-134. VSIMs 206, 208 emulate real SIMs 144, 146 to provide the virtual gateway 202, 204 with all the user subscription information and personalization required in order for the virtual gateway 202, 204 to be able to communicate with the BTS 142. The registered owner associated with the VSIM 206, 208 is charged for the costs associated with the communication between the virtual gateway 202, 204 and the BTS 142. The VSIM 206, 208 contains the same or similar information to that stored in the SIM 144, 146 of FIG. 1.

Connections 210, 212 are used to communicate between sensors 116-134 and the virtual gateways 202, 204 in the base transceiver station 142 instead of having a SIM card 144, 146 and associated conventional mobile device at each sensor 116-134 and using conventional mobile phone frequencies. Connections 206, 208 may be, for example, license-free ISM frequency bands such as the 868.000 MHz to 868.600 MHz, 915 MHz or 433.050 MHz to 434.790 MHz frequencies which are certified under ETSI standard ETS300-220, FCC15-247, 15-249. Such connections have a Line-of-Sight (LOS) range of up to 1 km using 25 mW (+15 dBm) power and up to 4 km using 500 mW (+27 dBm) power. The data rates may vary from 4.8 kbps to 100 kbps with typical data rates being 9.6 kbps using the 433 MHz and 868 MHz frequencies and 19.2 kbps using the 915 MHz frequency. Other frequencies or transmission standards may be used within the scope of embodiments of the present invention.

The use of license-free ISM frequency bands for the connections between the sensors 116-134 and the virtual gateways 202, 204 means that the connection point into the mobile telecommunications network is moved to the base transceiver station. This has the advantage that a VSIM 206, 208 may be used in place of a real SIM 144, 146. The VSIM 206, 208 may be located at base transceiver stations 142 which are part of the existing mobile phone network, thus avoiding the need to find a suitable location and a suitable power supply for the real SIM 144, 146. It also has the advantage that since the VSIM 206, 208 is located in the same location as the base transceiver station 142, that a VSIM 206, 208 simulating a SIM 144, 146 can be used, thus reducing the complexity and cost of the system. Small aerials for the license-free ISM frequency band are located on the base transceiver station 142 which transmit signals to, and receive signals from, the sensors 116-134.

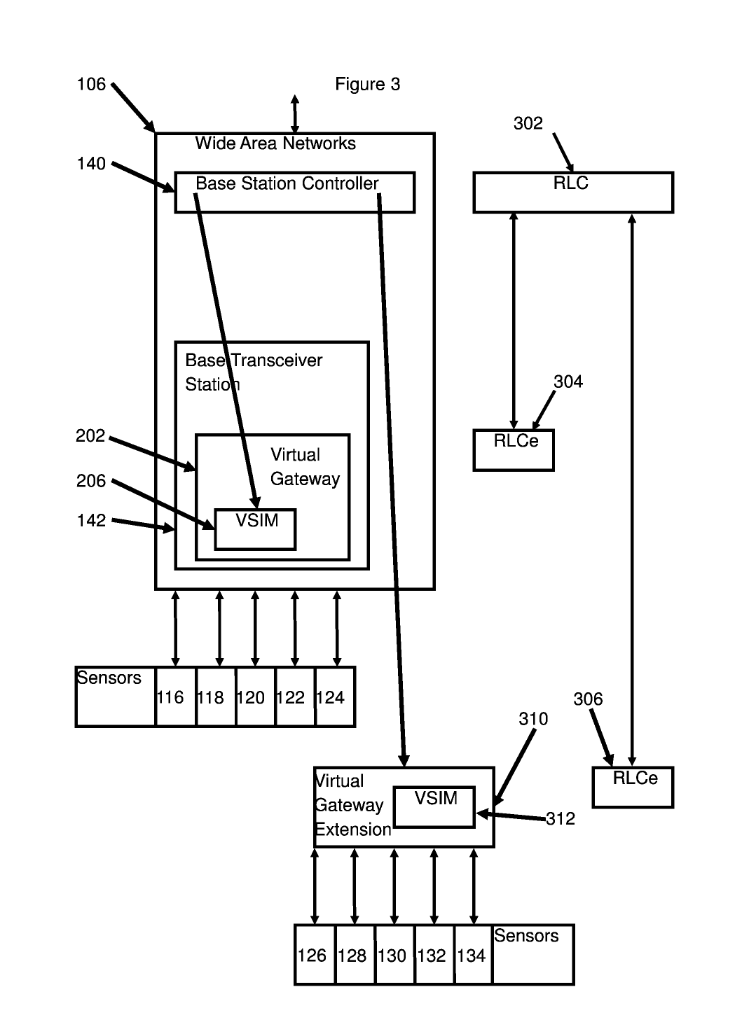

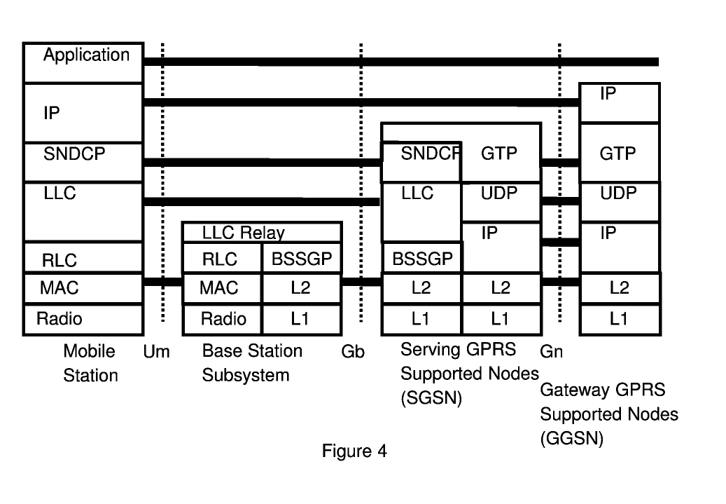

FIG. 3 shows an expanded view of a portion of the embodiment of FIG. 2 showing the protocols used between the BTSs 142 and the sensors 116-134. FIG. 4 shows prior art GPRS protocol stack used in an OpenBTS architecture. WAN 106, BSC 140, BTS 142, VSIM 206 and sensors 116-134 are the same as those shown in FIG. 2. BSC 140 uses an RLC protocol 302 to exchange data over the air between the BSC 140 and the VSIM card 206 located within the virtual gateway 202. In the first embodiment described above with reference to FIG. 2, the RLC protocol 302 is used to communicate with the BTS 142 which uses a Radio Link Control emulation (RLCe) protocol 304.

The RLC protocol 302 provides a reliable link between the BSC 142 and the gateway (108, 110 of FIG. 1), allowing transmission of RLC blocks in acknowledged or unacknowledged mode during an uplink or downlink Temporary Block Flow (TBF). The RLC protocol 302 is responsible for the segmentation of Logical Link Control (LLC) frames into RLC data blocks. Before being transmitted on the radio interface, these blocks are numbered by the transmitter so that the receiver is able to detect undecoded data blocks and request their selective retransmission. When all the RLC data blocks belonging to one LLC frame have been received, the RLC layer at the receiver side ensures the reassembly of the LLC frame. The RLC protocol also provides a similar mechanism for the transmission of Radio Link Control and Medium Access Control (RLC/MAC) control messages from the BSC 140 to the gateway 108, 110 of FIG. 1. The RLC protocol 302 is used to send and receive packets between the prior art gateway 108, 110 of FIG. 1 and the BSC 140 over a radio link. So the LLC protocol is the protocol located in the protocol stack of FIG. 4 above the RLC protocol. The LLC protocol invokes the RLC protocol to send its packet of data (PDU).

The RLC emulation (RLCe) 304 is a piece of software that provides to the LLC layer the same service as the RLC protocol 302 would to send its packet of data. However, this is an emulation and not a real RLC protocol because there is no wireless network between the virtual gateway 202 and the BSC 140 as the virtual gateway 202 may be located in the same processor or in the same equipment rack. For example, if the virtual gateway 202 is running on the same processor, the RLCe 304 layer may use an inter-process data transmission mechanism to emulate the sending of a PDU from the RLCe 304 side of the virtual gateway 202 to the RLCe 304 side of the BSC 140. The RLCe 304 layer on the receiving side then invokes a BSSGP (Base Station System GPRS Protocol) layer to send the data to the BSC 140 as if it was coming from a real physical gateway.

FIG. 3 also shows a second embodiment of the invention in which the BSC 140 communicates directly with a virtual gateway extension 310 in which a VSIM 312 is located. The BSC 140 uses an RLC protocol 302 to exchange data between the BSC 140 and the virtual gateway extension 310 having the VSIM 312 located within it using, for example, a TCP socket. The virtual gateway extension 310 uses an RLCe protocol 306.

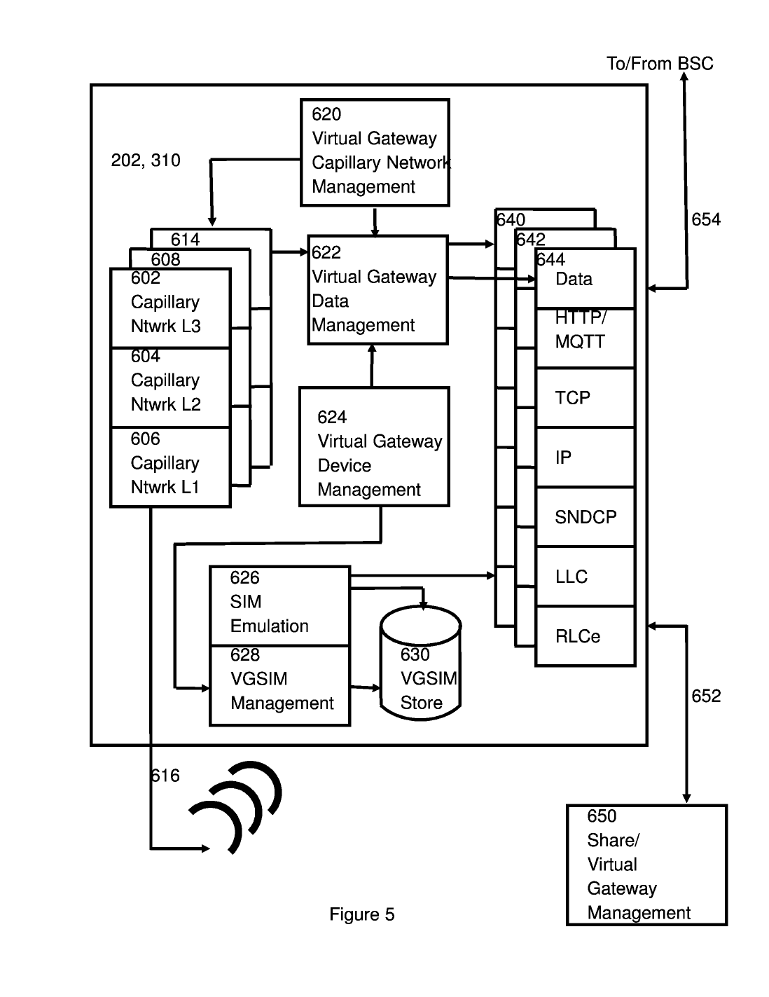

FIG. 5 shows the main components in an embodiment of a virtual gateway 202, 310 according to embodiments of the present invention. Capillary networks 602-606, 608, 614 are the same as shown in FIGS. 2 and 3. Virtual Gateway Capillary Network management 620 manages the capillary network including activating/deactivating the communication with capillary networks 602-606, 608, 614 and registering/de-registering new sensors 116-134 identified by sensor id. Virtual Gateway Data Management 622 manages the flow of data from capillary network 602-606, 618, and 614 to the protocol stacks 640, 642, and 644 shown in FIG. 4. Virtual Gateway Device Management 624 manages the orchestration of the software components running as part of virtual gateway 202, 204 for example to start/stop/configure/upgrade the software components in the right sequence as well as managing the communication with the Virtual Gateway Management 650 to create/update configuration parameters or to perform a remote reboot of the virtual gateway 202, 204 centrally. VGSIM Store 630 is a non-volatile memory similar to the secret element in a real SIM card. VGSIM Store 630 is preferably non-readable without the use of the proper keys. SIM Emulation 626 interfaces with the VGSIM Store 630 containing the credentials/data related of all activated Virtual SIMs and interfaces with other components of the virtual gateway 202, 204 (like the Radio Link Control emulation layer for example) to access the information contained into the Virtual SIMs. VGSIM Management 628 manages the VSIM 206, 312 lifecycle. It receives from the Shared Virtual Gateway Management 650 requests to activate (create), deactivate (delete), change (modify) a VSIM 206, 312 as if it was located in a real physical gateway in which there are one or more slots to insert one or more real SIMs, from which a real SIM can be removed and into which a real SIM can be inserted. VGSIM Management 628 can utilize as many instances of VSIMs 206, 312 as desired as long as there is enough memory in the Virtual Gateway 202, 310 and enough processing power to handle the protocol. This has the advantage that additional VSIMs can be added without physically making any changes.

Embodiments of the invention can take the form of a computer program accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-RW), and DVD.

What is claimed is:

1. A virtual gateway for communicating between one or more remote machine to machine capillary networks and a local base transceiver station, the virtual gateway comprising:
an interface for communicating with a local base transceiver station, the interface emulating a Radio Link Control (RLC) protocol in said communication;
an interface for communicating with one or more remote machine to machine capillary networks; and
a SIM emulation component for emulating a SIM card, the SIM card being used in association with the interface for communicating with the local base transceiver station.

2. The virtual gateway of claim 1, wherein the virtual gateway is co-located with the local base transceiver station.

3. The virtual gateway of claim 1, wherein the interface emulating a Radio Link Control (RLC) protocol uses an inter-process data transmission mechanism.

4. The virtual gateway of claim 1, wherein the interface for communicating with one or more remote machine to machine capillary networks uses short distance wired or wireless communication.

5. The virtual gateway of claim 1, wherein the virtual gateway uses GPRS protocols for communication with the local base transceiver station.

6. A method of communicating between one or more remote machine to machine capillary networks and a local base transceiver station, the method comprising:
providing an interface for communicating with a local base transceiver station, the interface emulating a Radio Link Control (RLC) protocol in said communication;
providing an interface for communicating with one or more remote machine to machine capillary networks; and
providing a SIM emulation component for emulating a SIM card, the SIM card being used in association with the interface for communicating with the local base transceiver station.

7. The method of claim 6, wherein the virtual gateway is co-located with the local base transceiver station.

8. The method of claim 6, wherein the interface emulating a Radio Link Control (RLC) protocol uses an inter-process data transmission mechanism.

9. The method of claim 6, wherein the interface for communicating with one or more remote machine to machine capillary networks using short distance wired or wireless communication.

10. The method of claim 6, wherein the virtual gateway uses GPRS protocols for communication with the local base transceiver station.

11. A computer program product for communicating between a remote machine to machine capillary network base and a local base transceiver station, the computer program product comprising:
a computer readable storage medium having computer readable program code embodied therewith, the computer readable program code executable by a processor to perform a method comprising:
providing an interface for communicating with a local base transceiver station, the interface emulating a Radio Link Control (RLC) protocol in said communication;
providing an interface for communicating with one or more remote machine to machine capillary networks; and
providing a SIM emulation component for emulating a SIM card, the SIM card being used in association with the interface for communicating with the local base transceiver station.

12. The computer program product of claim 11, wherein the virtual gateway is co-located with the local base transceiver station.

13. The computer program product of claim 11, wherein the interface emulating a Radio Link Control (RLC) protocol uses an inter-process data transmission mechanism.

14. The computer program product of claim 11, wherein the interface for communicating with one or more remote machine to machine capillary networks using short distance wired or wireless communication.

15. The computer program product of claim 11, wherein the virtual gateway uses GPRS protocols for communication with the local base transceiver station.
